(19) United States
(12) Patent Application Publication
(10) Pub. No.: US 2010/0309170 A1
(43) Pub. Date: Dec. 9, 2010

(54) Touch panel with injection-molded substrate

(75) Inventors: Kuang-Ta Chen, Tao-yuan (TW); Wen-Jung Wu, Tao-yuan (TW); Tsung-Min Tso, Tao-Yuan (TW); Jie-Bin Peng, Tao-yuan (TW); Chang-Yu Chen, Tao-yuan (TW)

Correspondence Address: BACON & THOMAS, PLLC, 625 SLATERS LANE, FOURTH FLOOR, ALEXANDRIA, VA, 22314-1176, US

(73) Assignee: Transtouch Technology Inc., Tao-yuan (TW)

(21) Appl. No.: 12/659,421

(22) Filed: Mar. 9, 2010

(30) Foreign Application Priority Data
Jun. 3, 2009 (CN) 200910143919.5

(51) Int. Cl. G06F 3/042

(52) U.S. Cl. 345/176

(57) ABSTRACT

A touch panel with injection-molded substrate includes a first transparent substrate formed through injection molding; a first electrically conductive film and a conductive-film-free zone provided on a first surface of the first transparent substrate; a first electrically conducting circuit provided on the conductive-film-free zone on the first surface of the first transparent substrate; a second electrically conductive film and a conductive-film-free zone provided on an opposing second surface of the first transparent substrate; and a second electrically conducting circuit provided on the conductive-film-free zone on the second surface of the first transparent substrate. With the injection-molded substrate, the touch panel can be differently shaped with accurate dimensions to meet customers' requirements.

### FIELD OF THE INVENTION

The present invention relates to a touch panel with injection-molded substrate, and more particularly, to a touch panel that has an injection-molded substrate and can therefore be differently shaped with accurate dimensions to meet customers' requirements.

### BACKGROUND OF THE INVENTION

Thanks to the development in flat panel display techniques, people can now enjoy very good display effect with a flat panel display. Moreover, due to the progress in the process technology, the flat panel display can be now manufactured at reduced cost and has become widely welcomed among consumers. To upgrade the usability of the flat panel display, manufacturers have further integrated the touch panel into the flat panel display and apply this new product in various kinds of electronic devices, such as mobile phones, so that users are allowed to perform different operations on electronic devices simply by touching the display panel thereof. Such operating mode has been considered not only as a more convenient but also highly humanized design.

Among others, resistive touch panel and capacitive touch panel are the most popular touch panels due to their relatively low manufacturing costs and good size compatibility with terminal products. Therefore, the resistive and the capacitive touch panel have been widely applied in electronic products.

The resistive touch panel structurally includes a first transparent substrate, a second transparent substrate, a binding layer, and a flexible circuit board. The first transparent substrate is provided on one surface thereof with a first electrically conductive film, a first electrode wire, and a first electrically conducting circuit. The second transparent substrate is provided on one surface thereof with a second electrically conductive film, a second electrode wire, and a second electrically conducting circuit. The binding layer can be a double-sided tape or a polymer binder for binding the first transparent substrate and the second transparent substrate to each other. The flexible circuit board is used to connect the circuits on the touch panel to an integrated circuit (IC) controller.

As to the capacitive touch panel, it structurally includes a first transparent substrate, which is provided on one surface thereof with a first electrically conductive film, a first electrode wire, and a first electrically conducting circuit, and on another opposing surface with a second electrically conductive film and a second electrode wire; and a flexible circuit board for connecting the circuits on the touch panel to an IC controller.

Generally speaking, to meet customized structural requirements, the substrate for the touch panel is undergone die stamping or laser cutting to pre-form a lens hole and a microphone hole at predetermined positions. For example, some mobile phones include an embedded touch panel, which usually has a lower substrate made of polycarbonate and served as a position for providing a lens thereat. While the polycarbonate substrate is easily to process, it has low light transmission. In the case of a lower substrate made of glass, the glass has good light transmission but is uneasy to process. In conclusion, either the resistive or the capacitive touch panel, the electrically conductive film(s) provided on the surface(s) of the substrate(s) thereof is (are) subject to damage and tends (tend) to form burr edges in the course of processing to thereby reduce the good yield of the touch panel.

It is therefore tried by the inventor to develop a touch panel with injection-molded substrate to overcome the drawbacks existed in the conventional touch panels.

### SUMMARY OF THE INVENTION

A primary object of the present invention is to provide a touch panel with injection-molded substrate, so that the injection-molded transparent substrate can show relatively complicated shapes to meet customer's requirements.

To achieve the above and other objects, the touch panel with injection-molded substrate according to an embodiment of the present invention mainly includes a first transparent substrate, which is formed through injection molding; a first electrically conductive film and a conductive-film-free zone provided on one surface of the first transparent substrate; a first electrically conducting circuit provided on the conductive-film-free zone; a second electrically conductive film and a conductive-film-free zone provided on another opposing surface of the first transparent substrate; and a second electrically conducting circuit provided on the second conductive-film-free zone. With the injection-molded first transparent substrate, the touch panel can be differently shaped with accurate dimensions to increase the good yield thereof. Moreover, with the injection-molded substrate, the touch panel can be widely applied in various manners to achieve the same good effect. And, the problems of burr edges of the substrate and the damaged electrically conductive films on the substrate as found in the conventional die-stamped substrate can be avoided.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a touch panel with injection-molded substrate according to a first embodiment of the present invention;

FIG. 2 is a variation of the first embodiment of the present invention;

FIG. 3 is an exploded perspective view of a touch panel with injection-molded substrate according to a second embodiment of the present invention;

FIG. 4 is an enlarged fragmentary view of the circuit provided on the touch panel of the present invention;

FIG. 5 is a variation of the second embodiment of the present invention;

FIG. 6 is an exploded perspective view of a touch panel with injection-molded substrate according to a third embodiment of the present invention;

FIG. 7 is a variation of the third embodiment of the present invention;

FIG. 8 is an assembled side view of the present invention; and

FIG. 9 is another assembled side view of the present invention.

### DETAILED DESCRIPTION OF THE PREFERRED EMBODIMENTS

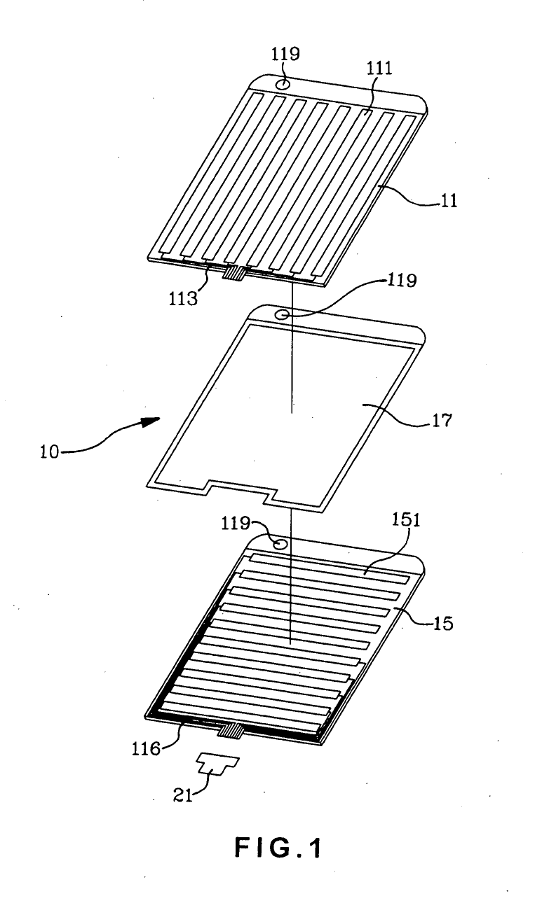

Please refer to FIG. 1 that is an exploded perspective view of a touch panel with injection-molded substrate according to a first embodiment of the present invention. The touch panel is generally denoted a reference numeral 10 and includes a first transparent substrate 11, a second transparent substrate 15, a binding layer 17, and a flexible circuit board 21.

The first transparent substrate 11 is formed through injection molding and is pre-formed with a microphone hole 119. A first electrically conductive film 111 is formed on a surface of the first transparent substrate 11 through vapor deposition, sputtering deposition, pulse laser deposition, chemical vapor deposition (CVD), spray pyrolysis, or sol-gel process to include a plurality of x-direction electrically conductive film zones and a plurality of conductive-film-free zones. Alternatively, a complete first electrically conductive film 111 is formed on a surface of the first transparent substrate 11 and then undergone chemical etching or laser etching to produce a plurality of x-direction strip-shaped electrically conductive film zones and a plurality of conductive-film-free zones. Alternatively, another electrically conductive film zone can be produced on a surface of the first transparent substrate 11 using laser, and a plurality of conductive-film-free zones can be produced on the surface of the first transparent substrate 11 by ink printing. Then, a first electrically conducting circuit 113 is provided on the conductive-film-free zones to connect to the x-direction strip-shaped electrically conductive film zones.

The second transparent substrate 15 can be formed through injection molding or be a flexible material, and is pre-formed with a microphone hole 119 corresponding to that on the first transparent substrate 11. A third electrically conductive film 151 is formed on a surface of the second transparent substrate 15 through vapor deposition, sputtering deposition, pulse laser deposition, chemical vapor deposition (CVD), spray pyrolysis, or sol-gel process to include a plurality of y-direction electrically conductive film zones and a plurality of conductive-film-free zones. Alternatively, a complete third electrically conductive film 151 is formed on a surface of the second, transparent substrate 15 and then undergone chemical etching or laser etching to produce a plurality of y-direction strip-shaped electrically conductive film zones and a plurality of conductive-film-free zones, or the conductive-film-free zones can be produced by ink printing. Then, a second electrically conducting circuit 116 is provided on the conductive-film-free zones of the second transparent substrate 15 to connect to the y-direction strip-shaped electrically conductive film zones.

The binding layer 17 is in the form of a frame being located between the first transparent substrate 11 and the second transparent substrate 15 to bind them to each other.

The flexible circuit board 21 is used to connect the circuits on the touch panels 10 to an integrated circuit (IC) controller (not shown). To give the touch panel an esthetic appearance and increased product value to meet customer's requirements, the second transparent substrate 15 can be provided on the surface thereof with light-transmitting zones 201 and non-light-transmitting zones 202, as shown in FIG. 9.

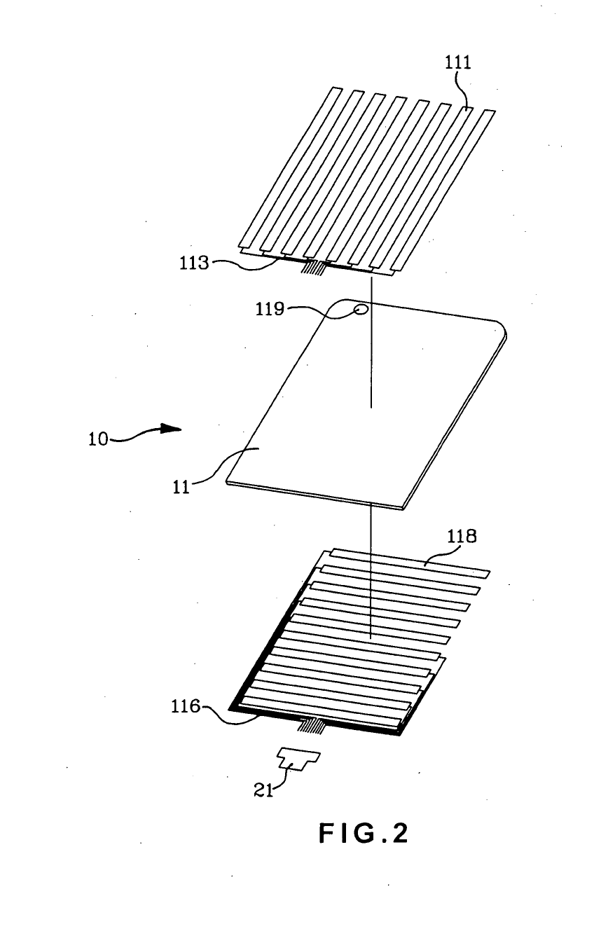

FIG. 2 is an exploded perspective view of a variation of the first embodiment of the present invention. The touch panel with injection-molded substrate in the variation of the first embodiment includes a first transparent substrate 11 that is formed through injection molding and is pre-formed with a microphone hole 119. A first electrically conductive film 111 is formed on a first surface of the first transparent substrate 11 through vapor deposition, sputtering deposition, pulse laser deposition, chemical vapor deposition (CVD), spray pyrolysis, or sol-gel process to include a plurality of x-direction electrically conductive film zones and a plurality of conductive-film-free zones. Alternatively, a complete first electrically conductive film 111 is formed on the first surface of the first transparent substrate 11 and then undergone chemical etching or laser etching to produce a plurality of x-direction electrically conductive film zones and a plurality of conductive-film-free zones. Alternatively, another electrically conductive film zone can be produced on the first surface of the first transparent substrate 11 using laser, and a plurality of conductive-film-free zones can be produced on the first surface of the first transparent substrate 11 by ink printing. Then, a first electrically conducting circuit 113 is provided on the conductive-film-free zones to connect to the x-direction electrically conductive film zones. A second electrically conductive film 118 is formed on an opposing second surface of the first transparent substrate 11 through vapor deposition, sputtering deposition, pulse laser deposition, chemical vapor deposition (CVD), spray pyrolysis, or sol-gel process to include a plurality of y-direction electrically conductive film zones and a plurality of conductive-film-free zones. Alternatively, a complete second electrically conductive film 118 is formed on the second surface of the first transparent substrate 11 and then undergone chemical etching or laser etching to produce a plurality of y-direction electrically conductive film zones and a plurality of conductive-film-free zones. Alternatively, a plurality of conductive-film-free zones can be produced on the second surface of the first transparent substrate 11 by ink printing. Then, a second electrically conducting circuit 116 is provided on the conductive-film-free zones to connect to the y-direction electrically conductive film zones. And, a flexible circuit board 21 is provided to connect the circuits on the touch panel to an IC controller (not shown).

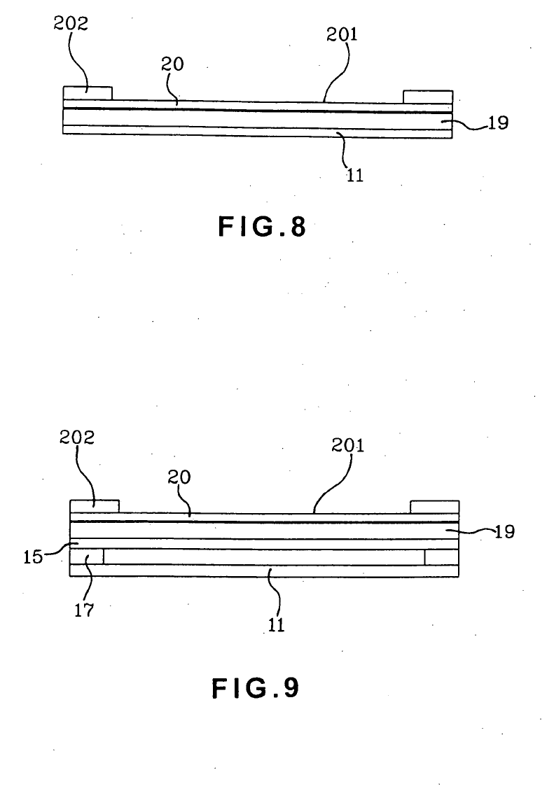

More specifically, the touch panel illustrated in FIG. 2 includes an injection-molded first transparent substrate 11, on which a microphone hole 119 is pre-formed. A first electrically conductive film 111 is formed on a first surface of the first transparent substrate 11 through vapor deposition, sputtering deposition, pulse laser deposition, chemical vapor deposition (CVD), spray pyrolysis, or sol-gel process to produce a plurality of customized patterns, keys and conductive-film-free zones. Alternatively, another electrically conductive film zone can be produced on the first surface of the first transparent substrate 11 using laser, and a plurality of conductive-film-free zones can be produced on the first surface of the first transparent substrate 11 by ink printing. Then, a first electrically conducting circuit 113 is provided on the conductive-film-free zones on the first surface of the first transparent substrate 11 to connect to the customized patterns and keys. To give the touch panel an esthetic appearance and increased product value to meet customer's requirements, the first transparent substrate 11 can be provided on one surface thereof with light-transmitting zones 201 and non-light-transmitting zones 202, as shown in FIG. 8.

With the injection-molded substrate 11 or substrates 11, 15, the touch panel 10 can be differently shaped with accurate dimensions to upgrade the good yield of the touch panel 10.

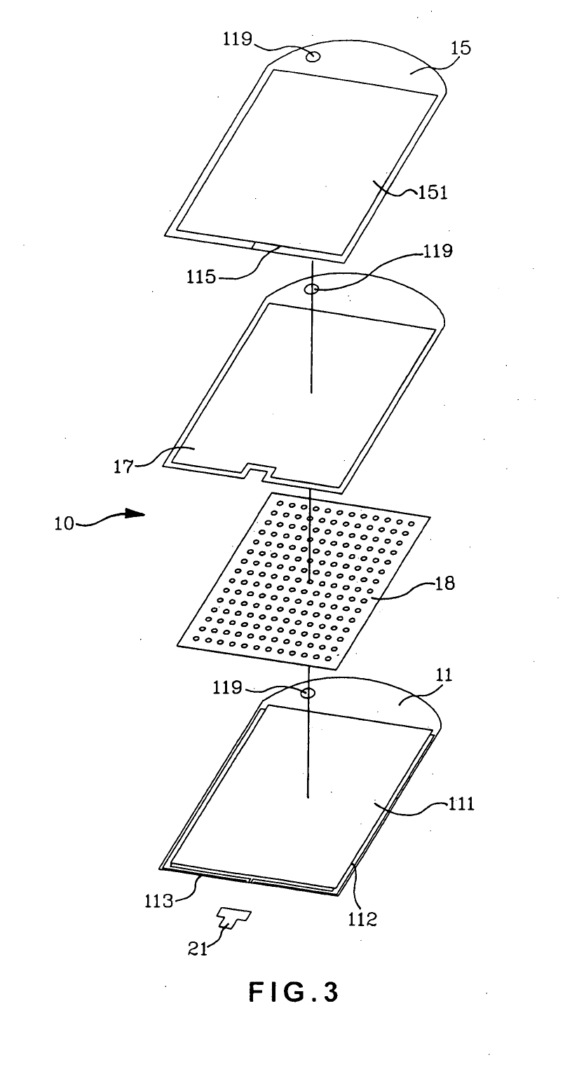

Please refer to FIG. 3 that is an exploded perspective view of a touch panel 10 with injection-molded substrate according to a second embodiment of the present invention. The touch panel 10 includes a first transparent substrate 11, a second transparent substrate 15, a binding layer 17, a plurality of spacers 18, and a flexible circuit board 21.

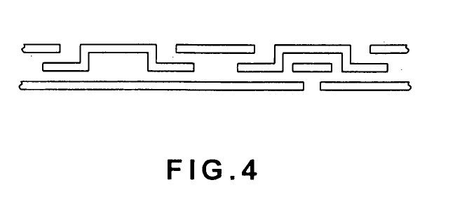

The first transparent substrate 11 is formed through injection molding and is pre-formed with a microphone hole 119. A first electrically conductive film 111 is formed on a surface of the first transparent substrate 11, and a first electrode wire 112 is provided on a surface of the first electrically conductive film 111. As shown in FIG. 4, the first electrode wire 112 is located at an inner side of a first transverse structure, which has a pattern including a substantially n-sectioned central portion, a first laterally extended portion and a second laterally extended portion, and a plurality of second transverse structure. A first electrically conducting circuit 113 is provided on a conductive-film-free zone of the first transparent substrate 11.

The second transparent substrate 15 can be formed through injection molding or be a flexible material, and is pre-formed with a microphone hole 119 corresponding to that on the first transparent substrate 11. A third electrically conductive film 151 is formed on a surface of the second transparent substrate 15, and a second electrode wire 115 is provided on the third electrically conductive film 151.

The binding layer 17 is in the form of a frame being located between the first transparent substrate 11 and the second transparent substrate 15 to bind them to each other.

The spacers 18 are located between the first and the third electrically conductive film 111, 151 to avoid short circuit therebetween.

The flexible circuit board 21 is used to connect the circuit on the touch panel 10 to an IC controller (not shown).

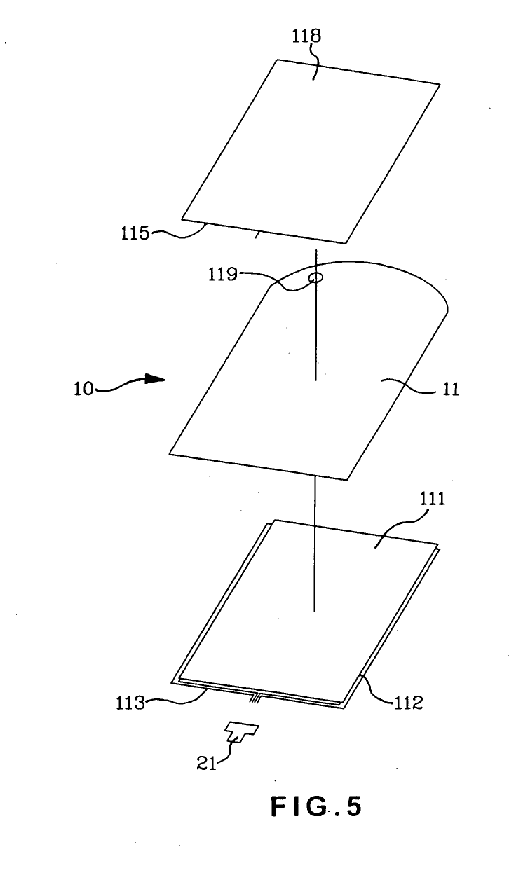

FIG. 5 is an exploded perspective view showing a variation of the second embodiment of the present invention. As shown, in the variation of the second embodiment, the touch panel includes a first transparent substrate 11, which is formed through injection molding and is pre-formed with a microphone hole 119. A first electrically conductive film 111 is formed on a first surface of the first transparent substrate 11, and a first electrode wire 112 is provided on the first electrically conductive film 111. As shown in FIG. 4, the first electrode wire 112 is located at an inner side of a first transverse structure, which has a pattern including a substantially n-sectioned central portion, a first laterally extended portion and a second laterally extended portion, and a plurality of second transverse structure. A first electrically conducting circuit 113 is provided on a conductive-film-free zone of the first transparent substrate 11. A second electrically conductive film 118 is formed on an opposing second surface of the first transparent substrate 11. A second electrode wire 115 is provided on the second electrically conductive film 118. A flexible circuit board 21 is used to connect the circuit on the touch panel to an IC controller (not shown).

Since the touch panel 10 according to the second embodiment of the present invention as shown in FIGS. 3 and 5 has injection-molded first transparent substrate 11 or injection-molded first and second transparent substrates 11, 15, the touch panel 10 can be differently shaped with accurate dimensions to upgrade the good yield thereof. Meanwhile, the problems of burr edges of the substrate and the damaged electrically conductive films on the substrate as found in the conventional die-stamped substrate can be avoided.

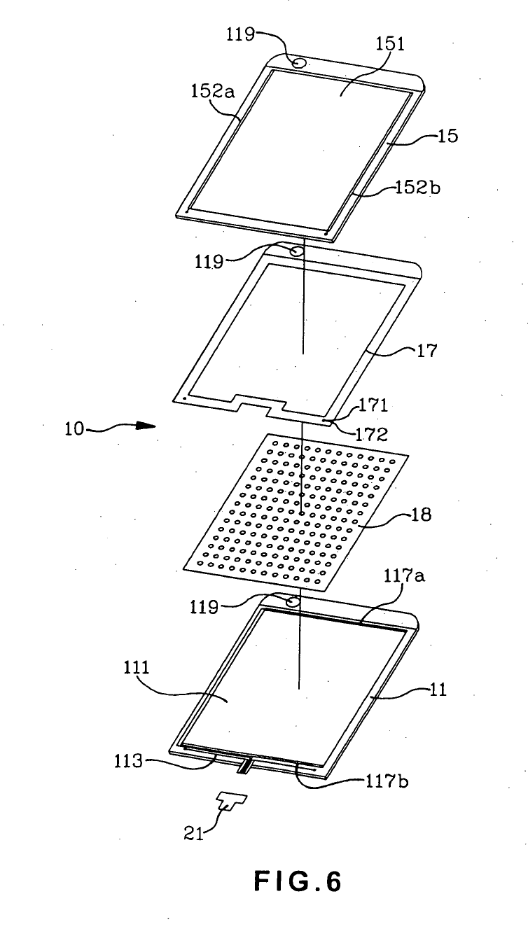

Please refer to FIG. 6, in which a touch panel 10 with injection-molded substrate according to a third embodiment of the present invention is shown. The touch panel 10 in the third embodiment includes a first transparent substrate 11, a second transparent substrate 15, a binding layer 17, a plurality of spacers 18, and a flexible circuit board 21.

The first transparent substrate 11 is formed through injection molding and is pre-formed with a microphone hole 119. A first electrically conductive film 111 is formed on a surface of the first transparent substrate 11, and a third electrode wire group 117 including two parallelly arranged electrode wires 117a, 117b is provided on the first conductive film 111. Alternatively, another electrically conductive film zone can be produced on a surface of the first transparent substrate 11 using laser, and a conductive-film-free zone can be produced on the surface of the first transparent substrate 11 by ink printing. Then, a first electrically conducting circuit 113 is provided on the conductive-film-free zone.

The second transparent substrate 15 can be formed through injection molding or be a flexible material, and is pre-formed with a microphone hole 119 corresponding to that on the first transparent substrate 11. The second transparent substrate 15 is arranged in parallel to the first transparent substrate 11. A third electrically conductive film 151 is formed on a surface of the second transparent substrate 15, and a fourth electrode wire group 152 including two parallelly arranged electrode wires 152a, 152b is provided on the third electrically conductive film 151.

The binding layer 17 is in the form of a frame being located between the first transparent substrate 11 and the second transparent substrate 15 to bind them to each other. The binding layer 17 is provided with at least one through hole 171 internally filled with an electrically conductive adhesive 172, and the first electrically conducting circuit 113 and the second electrode wires 152a, 152b are electrically connected to one another via the through hole 171 on the binding layer 17.

The flexible circuit board 21 is used to connect the circuit on the touch panel 10 to an IC controller (not shown).

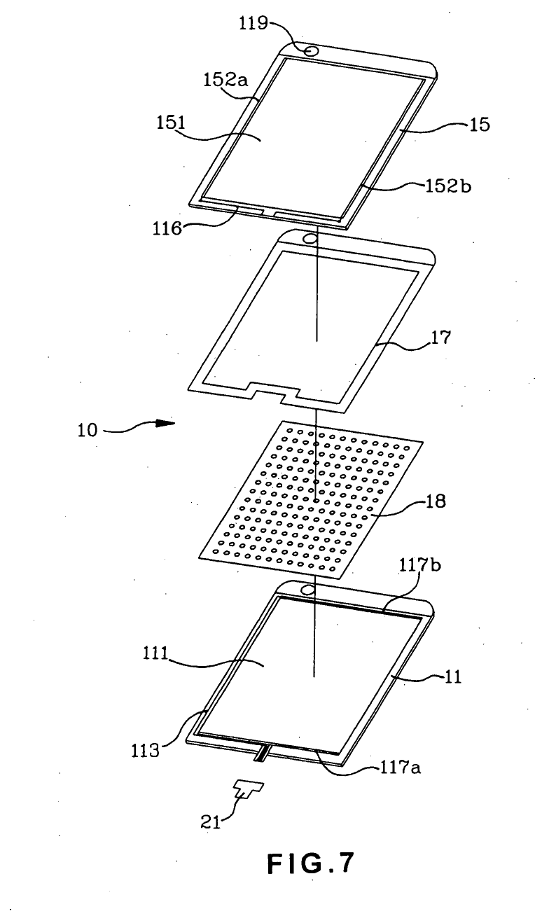

FIG. 7 is an exploded perspective view showing a variation of the third embodiment of the present invention. As shown, in the variation of the third embodiment, the touch panel 10 has a first transparent substrate 11, a second transparent substrate 15, a binding layer 17, a plurality of spacers 18, and a flexible circuit board 21. The first transparent substrate 11 is formed through injection molding, on which a microphone hole 119 is pre-formed. A first electrically conductive film 111 is formed on a surface of the first transparent substrate 11, and a third electrode wire group 117 including two parallelly arranged electrode wires 117a, 117b is provided on the first conductive film 111. Then, a first electrically conducting circuit 113 is provided on a conductive-film-free zone on the first transparent substrate 11.

The second transparent substrate 15 can be formed through injection molding or be a flexible material, and is pre-formed with a microphone hole 119 corresponding to that on the first transparent substrate 11. The second transparent substrate 15 is arranged in parallel to the first transparent substrate 11. A third electrically conductive film 151 is formed on a surface of the second transparent substrate 15. A fourth electrode wire group 152 including two parallelly arranged electrode wires 152a, 152b is provided on the third electrically conductive film 151. And, a second conducting circuit 116 is provided on a conductive-film-free zone on the second transparent substrate 15.

The binding layer 17 is in the form of a frame being located between the first transparent substrate 11 and the second transparent substrate 15 to bind them to each other. The binding layer 17 can be an optical adhesive, a double-sided tape, or a polymer binder.

The flexible circuit board 21 is used to connect the circuits on the touch panel 10 to an IC controller (not shown).

In the touch panels 10 according to the third embodiment of the present invention as shown in FIGS. 6 and 7, the spacers 18 are located between the first and the third electrically conductive film 111, 151 to avoid short circuit therebetween.

Please refer to FIGS. 8 and 9. To give the touch panel of the present invention an esthetic appearance and increased product value to meet customer's requirements, a flexible film 20 or a transparent material can be attached to a surface of the first transparent substrate 11 via an adhesive layer 19 as shown in FIG. 8, or be attached to a surface of the second transparent substrate 15 via an adhesive layer 19 as shown in FIG. 9. And, light-transmitting zones 201 and non-light-transmitting zones 202 are provided on the flexible film 20 or the transparent material. Preferably, the adhesive layer 19 is an optical adhesive, a double-sided tape, or a polymer binder.

With the above arrangements, the touch panel of the present invention can achieve the expected objects and effects, and is not restricted to a capacitive touch panel or any one of 4-wire, 5-wire, 6-wire, 7-wire and 8-wire resistive touch panels.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A touch panel with injection-molded substrate, comprising:
a first transparent substrate being formed through injection molding, and
a first electrically conductive film and a conductive-film-free zone being provided on a first surface of the first transparent substrate, and a first electrically conducting circuit being provided on the conductive-film-free zone on the first surface of the first transparent substrate.

2. The touch panel with injection-molded substrate as claimed in claim 1, further comprising a second electrically conductive film and a conductive-film-free zone being provided on an opposing second surface of the first transparent substrate, and a second electrically conducting circuit being provided on the conductive-film-free zone on the conductive-film-free zone on the opposing second surface of the first transparent substrate.

3. The touch panel with injection-molded substrate as claimed in claim 2, wherein the first electrically conductive film has a first electrode wire provided thereon, and the second electrically conductive film has a second electrode wire provided thereon.

4. A touch panel with injection-molded substrate, comprising:
a first transparent substrate being formed through injection molding, a first electrically conductive film and a conductive-film-free zone being provided on a surface of the first transparent substrate, and a first electrically conducting circuit being provided on the conductive-film-free zone on the first transparent substrate;
a second transparent substrate being optionally formed through injection molding or made of a flexible material; a third electrically conductive film and a conductive-film-free zone being provided on a surface of the second transparent substrate, and a second electrically conducting circuit being provided on the conductive-film-free zone on the second transparent substrate; and
a binding layer in the form of a frame being located between the first transparent substrate and the second transparent substrate to bind them to each other.

5. The touch panel with injection-molded substrate as claimed in claim 4, wherein the binding layer is selected from the group consisting of an optical adhesive, a double-sided tape, and a polymer binder.

6. The touch panel with injection-molded substrate as claimed in claim 4, wherein the first electrically conductive film has a first electrode wire or a third electrode wire group provided thereon; and the third electrically conductive film has a second electrode wire or a fourth electrode wire group provided thereon.

7. The touch panel with injection-molded substrate as claimed in claim 6, wherein the binding layer includes at least one through hole internally filled with an electrically conductive adhesive, and the first electrically conducting circuit and the fourth electrode wire group are electrically connected to one another via the through hole on the binding layer.

8. The touch panel with injection-molded substrate as claimed in claim 4, wherein the first and the third electrically conductive film are spaced from each other by a plurality of spacers, so as to maintain a fixed clearance therebetween.

9. The touch panel with injection-molded substrate as claimed in claim 2, wherein the first and the second electrically conductive film respectively include a plurality of spaced strips, and the strips of the first and the second electrically conductive film are extended in x-direction and y-direction, respectively.

10. The touch panel with injection-molded substrate as claimed in claim 4, wherein the first and the third electrically conductive film respectively include a plurality of spaced strips, and the strips of the first and the third electrically conductive film are extended in x-direction and y-direction, respectively.

11. The touch panel with injection-molded substrate as claimed in claim 2, wherein the first and the second electrically conductive film are formed through vapor deposition, sputtering deposition, pulse laser deposition, chemical vapor deposition (CVD), spray pyrolysis, and sol-gel process to include a plurality of conductive film zones and a plurality of conductive-film-free zones according to customized pattern and keys.

12. The touch panel with injection-molded substrate as claimed in claim 9, wherein the first and the second electrically conductive film are formed through vapor deposition, sputtering deposition, pulse laser deposition, chemical vapor deposition (CVD), spray pyrolysis, and sol-gel process to include a plurality of conductive film zones and a plurality of conductive-film-free zones according to customized pattern and keys.

13. The touch panel with injection-molded substrate as claimed in claim 2, wherein the first and the second electriclly conductive film are initially formed into a complete area and then undergone chemical etching or laser etching to produce a plurality of conductive film zones and a plurality of conductive-film-free zones according to customized pattern and keys.

14. The touch panel with injection-molded substrate as claimed in claim 9, wherein the first and the second electrically conductive film are initially formed into a complete area and then undergone chemical etching or laser etching to form a plurality of conductive film zones and a plurality of conductive-film-free zones according to customized pattern and keys.

15. The touch panel with injection-molded substrate as claimed in claim 4, wherein the first and the third electrically conductive film are initially formed into a complete area and then undergone chemical etching or laser etching to form a plurality of conductive film zones and a plurality of conductive-film-free zones according to customized pattern and keys.

16. The touch panel with injection-molded substrate as claimed in claim 10, wherein the first and the third electrically conductive film are initially formed into a complete area and then undergone chemical etching or laser etching to form a plurality of conductive film zones and a plurality of conductive-film-free zones according to customized pattern and keys.

17. The touch panel with injection-molded substrate as claimed in claim 1, further comprising a flexible film or a transparent material being attached to the first transparent substrate via an adhesive layer.

18. The touch panel with injection-molded substrate as claimed in claim 4, further comprising a flexible film or a transparent material being attached to the second transparent substrate via an adhesive layer.

19. The touch panel with injection-molded substrate as claimed in claim 17, wherein the adhesive layer is selected from the group consisting of an optical adhesive, a double-sided tape, and a polymer binder.

20. The touch panel with injection-molded substrate as claimed in claim 18, wherein the adhesive layer is selected from the group consisting of an optical adhesive, a double-sided tape, and a polymer binder.

21. The touch panel with injection-molded substrate as claimed in claim 1, wherein the surface of the first transparent substrate is provided with light-transmitting zones and non-light-transmitting zones.

22. The touch panel with injection-molded substrate as claimed in claim 4, wherein the surface of the second transparent substrate is provided with light-transmitting zones and non-light-transmitting zones.

23. The touch panel with injection-molded substrate as claimed in claim 17, wherein the flexible film or the transparent material is provided on a surface with light-transmitting zones and non-light-transmitting zones.

24. The touch panel with injection-molded substrate as claimed in claim 18, wherein the flexible film or the transparent material is provided on a surface with light-transmitting zones and non-light-transmitting zones.

25. The touch panel with injection-molded substrate as claimed in claim 1, further comprising a flexible circuit board that connects the first conducting circuit on the touch panel to an IC controller.

26. The touch panel with injection-molded substrate as claimed in claim 4, further comprising a flexible circuit board that connects first and second conducting circuits on the touch panel to an IC controller.

27. The touch panel with injection-molded substrate as claimed in claim 1, wherein the conductive-film-free zone is formed by ink printing.

28. The touch panel with injection-molded substrate as claimed in claim 4, wherein the conductive-film-free zones are formed by ink printing.
